(19) United States
(12) Patent Application Publication
(10) Pub. No.: US 2019/0208090 A1
(43) Pub. Date: Jul. 4, 2019

(54) IMAGE PROCESSING DEVICE AND ASSOCIATED IMAGE PROCESSING METHOD

(71) Applicant: MStar Semiconductor, Inc., Chu pei City (TW)

(72) Inventors: Kuo-Chen HUANG, ZHUBEI CITY (TW); Yin-An JIAN, ZHUBEI PEI CITY (TW); Hsing-Chih HUNG, ZHUBEI PEI CITY (TW); Chung-Yi CHEN, ZHUBEI PEI CITY (TW)

(21) Appl. No.: 16/222,168

(22) Filed: Dec. 17, 2018

Related U.S. Application Data
(60) Provisional application No. 62/611,550, filed on Dec. 29, 2017.

(51) Int. Cl. H04N 5/213; G06T 7/20; H04N 5/265; H04N 9/64; H04N 17/02

(52) U.S. Cl. CPC H04N 5/213; G06T 7/20; H04N 5/265; G06T 2207/30168; H04N 17/02; G06T 2207/10016; H04N 9/646

(57) ABSTRACT

An image processing device includes a flicker estimating circuit, a control circuit and an image processing circuit. The flicker estimating circuit estimates a flicker level of a frame according to at least one set of information corresponding to the frame to generate an estimated flicker result. The control circuit is coupled to the flicker estimating circuit, and generates at least one control signal according to the flicker level. The image processing circuit is coupled to the control circuit, and performs image processing on the frame according to the control signal.

This application claims the benefit of U.S. Provisional Application Ser. 62/611,550, filed Dec. 29, 2017, the subject matter of which is incorporated herein by reference.

### BACKGROUND OF THE INVENTION

### Field of the Invention

The invention relates to image processing, and more particularly to an image processing device and method dynamically performing image processing according to an estimated flicker result of each frame.

### Description of the Related Art

In a common image processing device, a spatial noise reduction (SNT) circuit or a motion compensation luminance reduction (MCNR) circuit is usually provided to eliminate noise to reduce flicker caused by noise, or a dynamic luminance control (DLC) circuit can be provided to directly adjust the luminance of an image to reduce flicker. However, because different frames of an image may have different flicker levels due to different image sources or different compression methods, if the same level of SNT, MCNR or DLC is applied to these different frames, image quality may become unstable and affect user experience.

### SUMMARY OF THE INVENTION

It is an object of the present invention to provide an image processing device and an associated method, which are capable of performing image adjustment on a frame according to an estimated flicker level of each frame. The present invention provides each frame with most appropriate image processing so as to maintain optimal image quality.

An image processing device is disclosed according to an embodiment of the present invention. The image processing device includes a flicker estimating circuit, a control circuit and an image processing circuit. The flicker estimating circuit estimates a flicker level of a frame according to at least one set of information corresponding to the frame to generate an estimated flicker result. The control circuit is coupled to the flicker estimating circuit, and generates at least one control signal according to the estimated flicker result. The image processing circuit is coupled to the control circuit, and performs image processing on the frame according to the control signal.

An image processing method is disclosed according to another embodiment of the present invention. The image processing method includes: estimating a flicker level of a frame according to at least one set of information corresponding to the frame to generate an estimated flicker result; generating at least one control signal according to the estimated flicker result; and performing image processing on the frame according to the control signal.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image processing circuit according to an embodiment of the present invention;

FIG. 2 is a detailed block diagram of a flicker estimating circuit according to a first embodiment of the present invention;

FIG. 3 is a detailed block diagram of a flicker estimating circuit according to a second embodiment of the present invention;

FIG. 4 is a detailed block diagram of a flicker estimating circuit according to a third embodiment of the present invention;

FIG. 5 is a detailed block diagram of a flicker estimating circuit according to a fourth embodiment of the present invention;

FIG. 6 is a detailed block diagram of an image processing circuit according to an embodiment of the present invention; and

FIG. 7 is a flowchart of an image processing method according to an embodiment of the present invention.

### DETAILED DESCRIPTION OF THE INVENTION

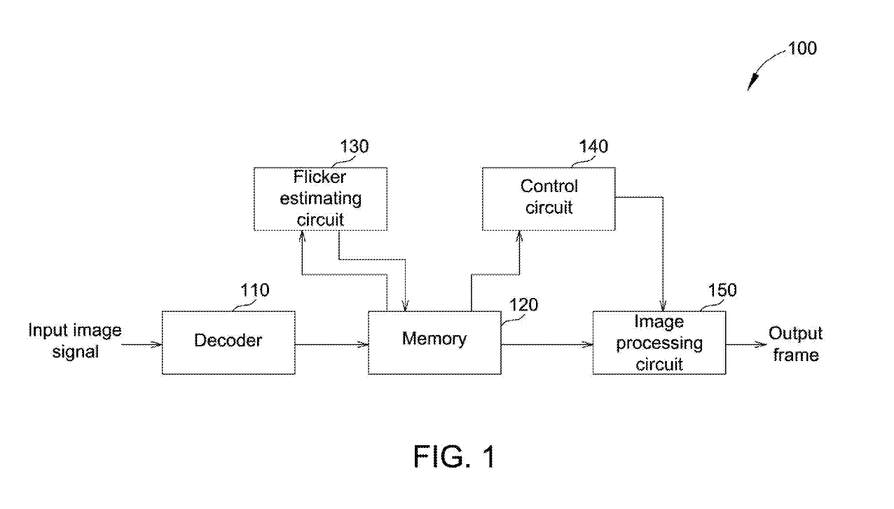

FIG. 1 shows a detailed block diagram of an image processing device 100 according to an embodiment of the present invention. As shown in FIG. 1, the image processing device 100 includes a decoder 110, a memory 120, a flicker estimating circuit 130, a control circuit 140 and an image processing circuit 150. In this embodiment, the image processing device 100 is applicable to a television or a set-top box, and generates multiple output frames to be displayed on a screen after receiving an input image signal from an external source.

In the image processing device 100, the decoder 110 decodes an input image signal received to generate information of multiple frames and associated metadata, and stores the information of the multiple frames and the associated metadata in the memory 120. The information of the multiple frames may be pixel values (or grayscale/luminance values) of pixels, and the metadata may include information such as the source, frame format encoding quality parameter or encoding compression rate of the input image signal. The flicker estimating circuit 130 reads the information and/or metadata of one frame from the memory 120, estimates a flicker level of the frame according to the information and/or metadata of the frame to generate an estimated flicker result, and stores the estimated flicker result in the memory 120. The control circuit 140 reads the estimated flicker result from the memory 120 to accordingly generate at least one control signal to the image processing circuit 150. The image processing circuit 150 performs image processing on the frame according to the at least one control signal to generate an output frame. More specifically, the image processing circuit 150 selects a predetermined image adjustment parameter according to the at least one control signal to perform image processing on the frame.

In this embodiment, the flicker estimating circuit 130 generates estimated flicker results corresponding to different frames, and the control circuit 140 generates control signals for different frames to control levels of image processing that the image processing circuit 150 performs on the images. Because most appropriate image processing of different frames can be performed according to the flicker levels of these frames, the problem of unstable image quality caused by the prior art that performs the same level of image processing on different frames can be resolved.

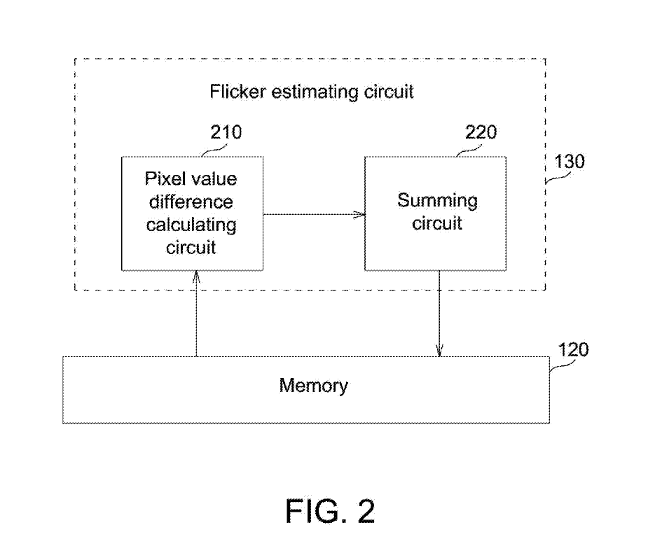

FIG. 2 shows a detailed block diagram of the flicker estimating circuit 130 according to a first embodiment of the present invention. As shown in FIG. 2, the flicker estimating circuit 130 includes a pixel value difference calculating circuit 210 and a summing circuit 220. In this embodiment, the pixel value difference calculating circuit 210 reads from the memory 120 multiple pixel values of one frame and a previous frame of the frame, and calculates respective differences between pixel values of multiple pixels in the frame and pixel values of multiple pixels located at the same positions in the previous frame to generate multiple difference values. The summing circuit 220 calculates the sum of the multiple difference values as the estimated flicker result and stores the estimated flicker result in the memory 120. In this embodiment, the sum calculated by the summing circuit 220 can reflect the flicker level of the frame; for example, the larger the sum is, the more severe the flicker level is. In this embodiment, one sum is used to reflect the flicker level of the frame; however, the present invention is not limited thereto. In another embodiment, a variance between the sum and a previous sum of the sum calculated by the summing circuit 220 may be used as the estimated flicker result. Alternatively, a corresponding relationship between the sum and multiple previous sums of the sum calculated by the summing circuit 220 may be used as the estimated flicker result.

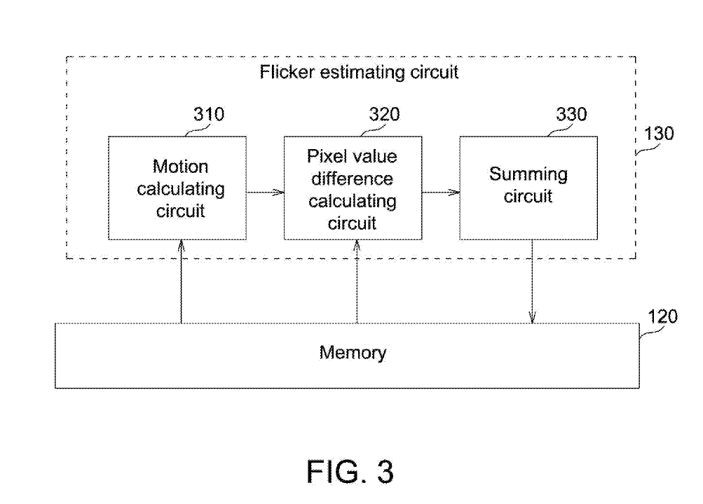

FIG. 3 shows a detailed block diagram of the flicker estimating circuit 130 according to a second embodiment of the present invention. As shown in FIG. 3, the flicker estimating circuit 130 includes a motion calculating circuit 310, a pixel value difference calculating circuit 320 and a summing circuit 330. In this embodiment, the motion calculating circuit 310 reads from the memory 120 multiple pixels of one frame and a previous frame of the frame, and calculates motion vectors of multiple blocks in the frame on the basis of the previous frame. The pixel value difference calculating circuit 320 reads from the memory 120 multiple pixel values of the frame and the previous frame, and calculates pixel value differences between multiple blocks in the frame and multiple blocks in the previous frame to generate multiple difference values. It should be noted that, the pixel value difference calculating circuit 210 compares difference values of pixels at the same position in different frames, whereas the pixel value difference calculating circuit 320 compares pixel difference values corresponding to the same object in an image in different frames (the positions may have been changed). The summing circuit 330 calculates a sum of the multiple difference values as the estimated flicker result, and stores the estimated flicker result in the memory 120. In this embodiment, the sum calculated by the summing circuit 330 can reflect the flicker level of the frame; for example, the larger the sum is, the more severe the flicker level of the frame is. In the embodiment, only one sum may be used to reflect the flicker level of the frame; however, the present invention is not limited thereto. In another embodiment, a variance between a sum and a previous sum of the sum calculated by the summing circuit 330 may be used as the estimated flicker result. Alternatively, a corresponding relationship between a sum and multiple previous sums calculated by the summing circuit 330 may be used as the estimated flicker result.

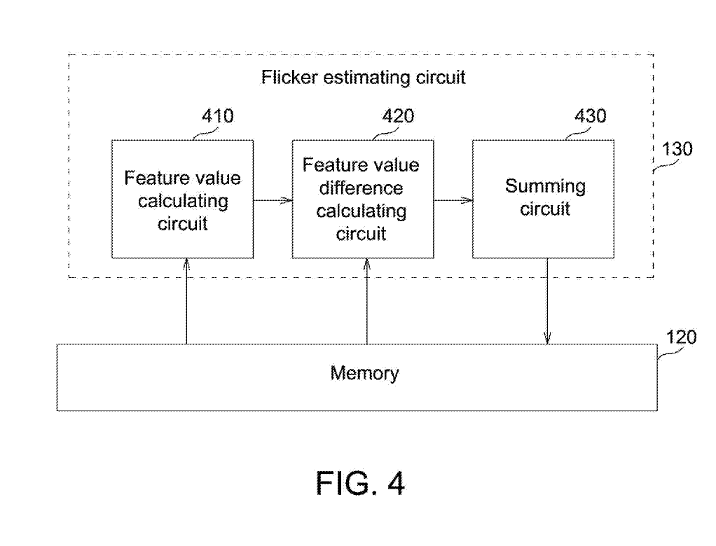

FIG. 4 shows a detailed block diagram of the flicker estimating circuit 130 according to a third embodiment of the present invention. As shown in FIG. 4, the flicker estimating circuit 130 includes a feature value calculating circuit 410, a feature value difference calculating circuit 420 and a summing circuit 430. In this embodiment, the feature value calculating circuit 410 reads from the memory 120 multiple pixels of one frame to calculate multiple feature values in the frame, wherein the multiple feature values may be a noise intensity, complexity or luminance value of one pixel or one block of the frame, and the noise intensity and complexity may be accordingly obtained by performing calculation on the multiple pixels by using a Sobel filter or other low-pass/band-pass filters. In this embodiment, the multiple feature values of the frame generated by the feature value calculating circuit 410, in addition to being provided to and used by the feature value difference calculating circuit 420, may also be stored in the memory 120 for subsequent use. The feature value difference calculating circuit 420 reads from the memory 120 multiple feature values of a previous frame of the frame, and calculates differences between the multiple feature values in the frame generated by the feature value calculating circuit 420 and multiple feature values of a previous frame to generate multiple difference values. The summing circuit 430 calculates a sum of the multiple differences as the estimated flicker result, and stores the estimated flicker result in the memory 120. In this embodiment, the sum calculated by the summing circuit 430 can reflect the flicker level of the frame; for example, the larger the sum is, the more severe the flicker level of the frame is. In the embodiment, only one sum may be used to reflect the flicker level of the frame; however, the present invention is not limited thereto. In another embodiment, a variance between a sum and a previous sum of the sum calculated by the summing circuit 430 may be used as the estimated flicker result. Alternatively, a corresponding relationship between a sum and multiple previous sums calculated by the summing circuit 430 may be used as the estimated flicker result.

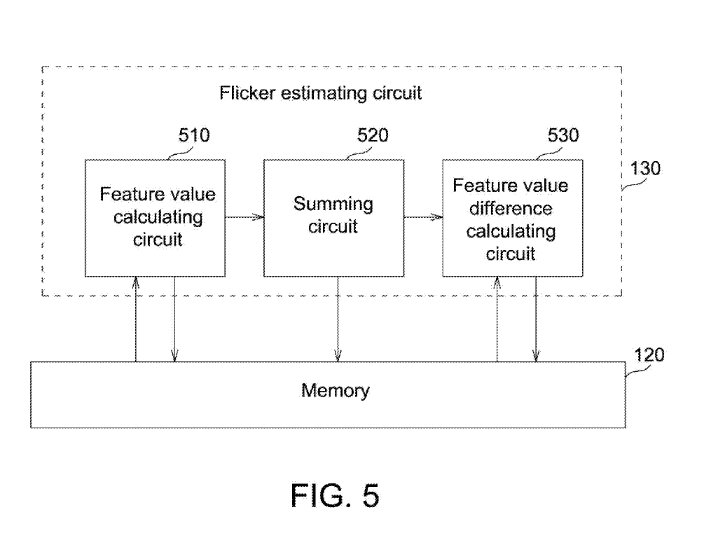

FIG. 5 shows a detailed block diagram of the flicker estimating circuit 130 according to a fourth embodiment of the present invention. As shown in FIG. 5, the flicker estimating circuit 130 includes a feature value calculating circuit 510, a summing circuit 520 and a feature value difference calculating circuit 530. In this embodiment, the feature value calculating circuit 510 reads from the memory 120 multiple pixel values of one frame to calculate multiple feature values of the frame, wherein the multiple feature values may be a noise intensity, complexity or luminance value of one pixel or one block in the frame. The summing circuit 520 calculates a sum of the multiple feature values in the frame. The sum, in addition to being provided to the feature value difference calculating circuit 530, is also stored in the memory 120 for subsequent use. The feature value difference calculating circuit 530 reads from the memory 120 a feature value sum of a previous frame of the frame and calculated by the summing circuit 520, and calculates a difference between the feature value sum of the frame and the feature value sum of the previous frame, as the estimated flicker result, and stores the estimated flicker result in the memory 120. In this embodiment, one sum is used to reflect the flicker level of the frame; however, the present invention is not limited thereto. In another embodiment, a variance between a sum and a previous sum of the sum calculated by the summing circuit 520 may be used as the estimated flicker result. Alternatively, a corresponding relationship between a sum and multiple previous sums calculated by the summing circuit 520 may be used as the estimated flicker result.

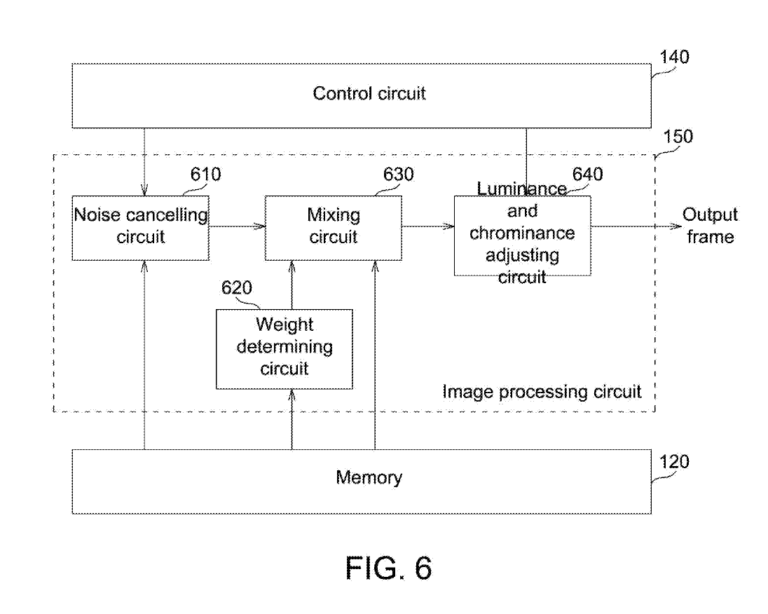

FIG. 6 shows a detailed block diagram of the image processing circuit 150 according to an embodiment of the present invention. As shown in FIG. 6, the image processing circuit 150 includes a noise cancelling circuit 610, a weight determining circuit 620, a mixing circuit 630 and a luminance and chrominance adjustment circuit 640. In this embodiment, the noise cancelling circuit 610, which may be implemented by a spatial band-pass filter or a temporal band-pass filter, receives from the control circuit 140 a control signal corresponding to a frame, and performs noise cancellation according to the control signal on the frame read from the memory 120 to generate a noise cancelled frame. More specifically, the noise cancelling circuit 610 may select a predetermined image adjustment parameter according to the control signal to perform noise cancellation on the frame. For example, for a frame having a higher flicker level, the control circuit 140 generates a control signal to control the noise cancelling circuit 610 to perform stronger noise cancellation; for a frame having a lower flicker level, the control circuit 140 generates a control signal to control the noise cancelling circuit 610 to perform weaker noise cancellation. However, the noise cancellation performed on a frame usually leads to more blurry image details, which is equivalently reducing the sharpness of the image. Thus, the weight determining circuit 620 reads from the memory 120 the frame to determine the complexity of the frame or border positions of the image, so as to determine weighting values of a plurality of pixels of the frame. The mixing circuit 630 then performs weighted addition on the frame and the noise cancelled frame to generate a mixed frame. In one embodiment, when a pixel of a frame is determined to be located at a border of an image or has a higher complexity, the pixel has a higher weighting value, so as to prevent loss of image details due to the noise cancellation. That is to say, for the pixel in the mixed frame, the frame (the original frame) has a higher weighting value compared to the noise cancelled frame. The luminance and chrominance adjusting circuit 630 receives the control signal of the frame from the control circuit 140, and performs dynamic luminance control (DLC) or color engine control on the mixed frame according to the control signal to generate an output frame. More specifically, the luminance and chrominance adjusting circuit 640 can select a predetermined image parameter according to the control signal to perform DLC or color engine control on the frame.

It should be noted that, in the embodiment in FIG. 6, the control circuit 140 uses the control signal generated according to the flicker level of the frame to simultaneously control the noise cancelling circuit 610 and the luminance and chrominance adjusting circuit 640. However, in other embodiments of the present invention, the control circuit 140 may use the control signal to control only the noise cancelling circuit 610, and the adjustment of the luminance and chrominance adjusting circuit 640 is not determined according to the flicker level of the frame. Alternatively, the control circuit 140 may use the control signal to control only the luminance and chrominance adjusting circuit 640, and the adjustment of the noise cancelling circuit 610 is not determined according to the flicker level of the frame. It should be noted that the design modifications above are all encompassed within the scope of the present invention.

In the embodiments above, the flicker estimating circuit respectively estimates flicker levels of multiple frames according to pixel values of the multiple frames; however, the present invention is not limited thereto. In other embodiments, because some information contained in the metadata of the frames can reflect the flicker levels of the frames, e.g., the source, frame format, encoding quality parameter or encoding compression rate of an input image signal, the flicker estimating circuit 130 can separately estimate the flicker level of the frame according to the contents of the metadata of the frames. For example, the flicker estimating circuit 130 can estimate a flicker level of a frame according to both pixel values and metadata of one frame, or estimate the flicker level of the frame only according to the metadata of the frame. It should be noted that the design modifications above are all encompassed within the scope of the present invention.

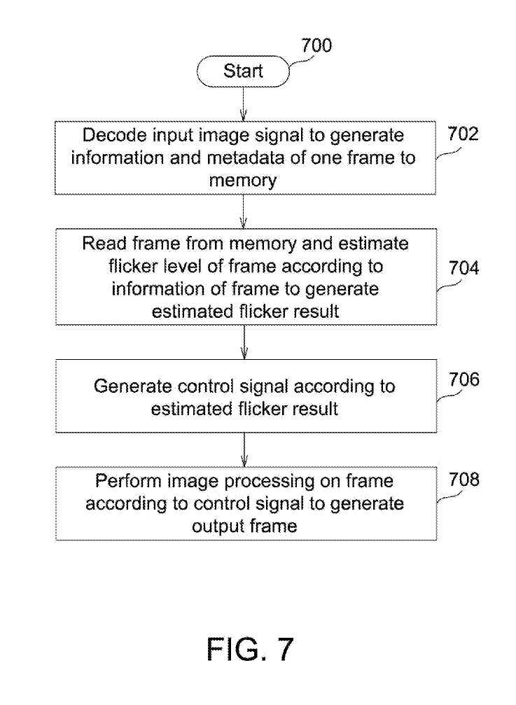

FIG. 7 shows a flowchart of an image processing method according to an embodiment of the present invention. With reference to the disclosed details in FIGS. 1 to 6, the process of the image processing method includes the following steps.

In step 700, the process begins.

In step 702, an input image signal is decoded to generate information and metadata of one frame to a memory.

In step 704, the frame is read from the memory, and a flicker level of the frame is estimated according the information of the frame to generate an estimated flicker result.

In step 706, a control signal is generated according to the estimated flicker result.

In step 708, image processing is performed on the image according to the control signal to generate an output frame.

In summary, in the image processing device and the associated method of the present invention, flicker levels of different frames are estimated to generate a most appropriate control signals to perform image processing on the frames, thus providing different frames with most appropriate image processing and maintaining optimum image quality.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded with the broadest interpretation so as to encompass all such modifications and similar arrangements and procedures.

What is claimed is:

1. An image processing device, comprising:
a flicker estimating circuit, estimating a flicker level of at least one set of information corresponding to a frame to generate an estimated flicker result;
a control circuit, generating at least one control signal according to the estimated flicker result; and
an image processing circuit, performing image processing on the frame according to the control signal.

2. The image processing device according to claim 1, wherein the flicker estimating circuit estimates flicker levels of a plurality of frames according to a plurality of sets of information corresponding to the plurality of frames to generate a plurality of estimated flicker results, respectively; the control circuit generates a plurality of control signals according to the plurality of estimated flicker levels, respectively; and the image processing circuit performs image processing on the plurality of frames according to the plurality of control signals, respectively.

3. The image processing device according to claim 1, wherein the flicker estimating circuit comprises:
a pixel value difference calculating circuit, calculating differences between a plurality of pixel values in the frame and a plurality of pixel values in a previous frame to generate a plurality of difference values; and
a summing circuit, coupled to the pixel value difference calculating circuit, calculating a sum of the plurality of difference values to generate the estimated flicker result.

4. The image processing device according to claim 1, wherein the flicker estimating circuit comprises:
a motion calculating circuit, calculating a plurality of motion vectors of a plurality of blocks in the frame on the basis of a previous frame;
a pixel value difference calculating circuit, calculating pixel value differences between a plurality of blocks in the frame and a plurality of blocks in the previous frame according to the plurality of motion vectors to generate a plurality of difference values; and
a summing circuit, coupled to the pixel value difference calculating circuit, calculating a sum of the plurality of difference values to generate the estimated flicker result.

5. The image processing device according to claim 1, wherein the flicker estimating circuit comprises:
a feature value calculating circuit, calculating a plurality of feature values in the frame;
a feature value difference calculating circuit, calculating differences between the plurality of feature values in the frame and a plurality of feature values in a previous frame to generate a plurality of difference values; and
a summing circuit, coupled to the feature value difference calculating circuit, calculating a sum of the plurality of difference values to generate the estimated flicker result.

6. The image processing device according to claim 5, wherein each of the plurality of feature values is a luminance value, a noise intensity or a complexity of a pixel or a block of the frame.

7. The image processing device according to claim 1, wherein the flicker estimating circuit comprises:
a feature value calculating circuit, calculating a plurality of feature values in the frame;
a summing circuit, coupled to the feature value calculating circuit, calculating a sum of the plurality of feature values; and
a feature value difference calculating circuit, calculating a difference between the sum of the plurality of feature values in the frame and a sum of a plurality of feature values in a previous frame to generate the estimated flicker result.

8. The image processing device according to claim 7, wherein each of the plurality of feature values is a luminance value, a noise intensity or a complexity of a pixel or a block of the frame.

9. The image processing device according to claim 1, further comprising:
a decoder, decoding an input image signal to generate the frame and corresponding image information;
wherein, the flicker estimating circuit estimates the flicker level of the frame according to the image information.

10. The image processing device according to claim 9, wherein the image information is at least one of a source, a frame format, an encoding quality parameter and an encoding compression rate of the input image signal.

11. The image processing device according to claim 1, wherein the image processing circuit comprises:
a noise cancelling circuit, performing noise cancellation on the frame according to the control signal to generate a noise cancelled frame;
a weight determining circuit, determining a plurality of weighting values of different pixels or different blocks in the frame; and
a mixing circuit, performing weighted addition on the frame and the noise cancelled frame according to the weighting values to generate a mixed frame.

12. The image processing device according to claim 11, wherein the image processing circuit further comprises:
a luminance and chrominance adjusting circuit, coupled to the mixing circuit, dynamically adjusting at least one of luminance and chrominance of the mixed frame according to the control signal to generate an output frame.

13. The image processing device according to claim 1, wherein the image processing circuit comprises:
a noise cancelling circuit, performing noise cancellation on the frame to generate a noise cancelled frame;
a weight determining circuit, determining a plurality of weighting values of a plurality of pixels or a plurality of blocks in the frame;
a mixing circuit, performing weighted addition on the frame and the noise cancelled frame according to the weighting values to generate a mixed frame; and
a luminance and chrominance adjusting circuit, coupled to the mixing circuit, dynamically adjusting luminance and chrominance of the mixed frame according to the control signal to generate an output frame.

14. An image processing method, comprising:
estimating a flicker level of a frame according to at least one set of information corresponding to the frame to generate an estimated flicker result;
generating at least one control signal according to the estimated flicker result; and
performing image processing on the frame according to the control signal.

15. The image processing method according to claim 14, further comprising:
estimating flicker levels of a plurality of frames according to a plurality of sets of information corresponding to the plurality of frames to generate a plurality of estimated flicker results, respectively;
generating a plurality of control signals according to the plurality of estimated flicker levels, respectively; and
performing image processing on the plurality of frames according to the plurality of control signals, respectively.

16. The image processing method according to claim 14, wherein the step of generating the estimated flicker result comprises:
calculating differences between a plurality of pixel values in the frame and a plurality of pixel values in a previous frame to generate a plurality of difference values; and
calculating a sum of the plurality of difference values to generate the estimated flicker result.

17. The image processing method according to claim 14, wherein the step of generating the estimated flicker result comprises:
calculating a plurality of motion vectors of a plurality of blocks in the frame on the basis of a previous frame;
calculating pixel value differences between a plurality of blocks in the frame and a plurality of blocks in the previous frame according to the plurality of motion vectors to generate a plurality of difference values; and
calculating a sum of the plurality of difference values to generate the estimated flicker result.

18. The image processing method according to claim 14, wherein the step of generating the estimated flicker result comprises:
calculating a plurality of feature values in the frame;
calculating differences between the plurality of feature values in the frame and a plurality of feature values in a previous frame to generate a plurality of difference values; and
calculating a sum of the plurality of difference values to generate the estimated flicker result.

19. The image processing method according to claim 18, wherein each of the plurality of feature values is a luminance value, a noise intensity or a complexity of a pixel or a block of the frame.

20. The image processing method according to claim 14, further comprising:
decoding an input image signal to generate the frame and corresponding image information; and
the step of generating the control signal according to the estimated flicker result comprises:
generating the control signal according to the image information.
